(19) United States
(12) Patent Application Publication
(10) Pub. No.: US 2024/0269721 A1
(43) Pub. Date: Aug. 15, 2024

(54) Apparatus for destroying electronic data and providing selective storage

(71) Applicant: Phiston Technologies, Inc., Miramar, FL (US)

(72) Inventors: M. Ali Ebadian, Miramar, FL (US); Raul Travieso, Miami, FL (US); Douglas Graham, Miramar, FL (US)

(21) Appl. No.: 18/167,461

(22) Filed: Feb. 10, 2023

(51) Int. Cl. B09B 3/35; B09B 3/80

(52) U.S. Cl. CPC B09B 3/35; B09B 3/80; B09B 2101/15

(57) ABSTRACT

An apparatus for destroying electronic data and providing selective storage for recycling having a first stage for shredding data storage devices into particles less than 20 mm×20 mm; a second stage that separates metal particles from non-metal particles; and a third stage for shredding non-metal into particle sizes of less than 2 mm×2 mm. A first bin is used to collect separated metal particles, a second bin is used to collect separated non-metal particles, and a vacuum system is used to collect airborne particles.

### RELATED PRIOR ART

This application is related to U.S. Pat. No. 11,389,805 issued Jul. 19, 2022 and entitled Method and Apparatus for HDD and Electronic Waste Disposal.

### FIELD OF THE INVENTION

This invention is related to the field of sensitive material destruction and, in particular, to apparatus for destroying electronic data and providing selective storage by separating particles and further shredding non-metal particles to less than 2 mm×2 mm.

### BACKGROUND OF THE INVENTION

Sensitive information is commonly stored on hard disk drives “HDD”, solid state drives “SSD”, and the like devices used for storage of data. The storage devices are coupled to motherboards, switches, caddies, brackets and the like; components which may be difficult to separate when the storage device has to be replaced or otherwise disposed of. It is critical that all data disposed of is unrecoverable. Government loss of sensitive data can be catastrophic. Business loss of sensitive date can result in trade secret theft and business advantage over a competitor. Individual loss of sensitive data can result in identity theft. No matter how trivial the theft may appear, the resulting harm can be irreparable.

When the life of a data storage device has ended, ideally the memory unit is removed from service and physically destroyed to assure that the stored information cannot be retrieved. Various apparatuses exist wherein the stored digital data is electronically or physically destroyed upon removal of the data storage. The goal being to assure that any sensitive material on the disk has been rendered unusable.

Various data destroying apparatus are described in Applicant's prior patents such as U.S. Pat. No. 7,324,321 for a Degaussing Apparatus; U.S. Pat. No. 7,852,590 for a Solid State Memory Decommissioner; U.S. Pat. No. 8,064,183 for a Capacitor Based Bi-Directional Degaussing Apparatus; U.S. Pat. No. 8,794,559 for a Solid State Storage Device Crusher; U.S. Pat. No. 9,776,192 for a Comminuting Apparatus; U.S. Pat. No. 10,071,382 for a Solid State Drive Disintegrator; U.S. Pat. No. 10,242,699 for a Single Pulse Degaussing Device; and U.S. Pat. No. 10,657,345 for a Media Destruction Verification Apparatus.

Data storage devices can be changed out due to lack of capacity or speed, mechanical malfunction, or simply due to a computer hardware/software upgrade. However, it is not always practical to separate the data storage device from the underlying supporting components. It is not uncommon for the entire computer to be disposed of and, if the consumer is not cognizant of which storage device is to be removed, the data storage device may be discarded with all data readily accessible. While certain types of devices used to store electronic media is easily removed, switchboxes, solid state drives, and other devices that may employ flash memory may require absolute destruction to help ensure that meaningful data cannot be extracted from the disks. While one solution is to shred the HDD, the disposal of only the HDD does not address other flash memory storage. Waste created by support components such as high-capacity hard drives with brackets or sleds, heat resistant magnetic recording (HAMR), microwave assisted magnetic recording (MAMR), perpendicular magnetic recording (PMR), rack switches, switch boxes, spindles, and so forth may be untouched. For this reason, the proper way to destroy media would be to destroy the memory storage and all associated components. However, simply shredding material leads to a mixture of metal and plastic making the waste non-recyclable leading to yet another problem. The millions of electronic devices that are disposed of that are shredded result in contaminated waste. Those devices that are not shredded may include sensitive data that can be absconded with and will consume unnecessary air space in landfills. For instance, a desktop computer placed in a landfill will result in a large airspace within the cabinet that consumes valuable landfill. Removal of the HDD may protect certain sensitive material but any flash memory left with the computer remains accessible and may include additional sensitive material. Further, removal of an HDD from a laptop is difficult wherein an owner may simply dispose of the laptop in a landfill in hopes that a nefarious act will not take place. Simply shredding the electronic device results in unusable contaminated waste.

What is desired is an apparatus for destroying data storage devices and associated component by a three-stage process capable of reducing electronic waste to a particle size of less than 2 mm×2 mm.

### SUMMARY OF THE INVENTION

Disclosed is an apparatus to destroy a data storage device and render the device for disposal and/or recycling. The apparatus employs a first stage of rough cutting wherein the data storage device is shredded into pieces approximately 20 mm×20 mm; a second stage that separates the shredded pieces by use of a magnetized roller having a scraper to direct material consisting of metal to a first bin and directing non-metal material to a third stage; the third stage further shredding the remaining material into particle size of less than 2 mm×2 mm.

An objective of the invention is to improve the prior art by providing a single apparatus having stages for shredding and separating of material wherein the apparatus destroys all media and separates the shredded particles for proper recycling to a particle size of less than 2 mm×2 mm, and separate metal from non-metal particles.

Accordingly, it is an objective of the instant invention to provide shredding of HDD and magnetic data carriers to a security level of less than H7 per DIN 66399.

Another objective of the invention is to have a first stage cut to reduce all material to 20 mm×20 mm or less, a second stage to separate metal based components such a brackets and spindles; and a third stage to have a fine cut particle size of 2 mm×2 mm for final destruction. It is noted that metal materials would not carry data storage wherein 20 mm×20 mm size is suitable.

It is a further objective of the instant invention to employ a magnetized roller in the second stage together with a scraper to separate metal material from the magnetized roller.

Yet still another objective of the invention is provide an apparatus for treating media storage devices and electronic waste for disposal having relatively dust free destruction at a rate of about 5-10 seconds per device.

Yet another objective of the invention is to teach the use of a rotor based shredder having blades attached to the rotor at a 2 degree slope, the slope gives the advantage of generating a composition cutting force that allows the blades to shear particles.

Still another objective of the invention is to eliminate the need disassemble media storage devices, saving time and labor costs.

Other objectives and advantages of this invention will become apparent from the following description taken in conjunction with any accompanying drawings wherein are set forth, by way of illustration and example, certain embodiments of this invention.

### BRIEF DESCRIPTION OF THE FIGURES

FIG. 1 is a front plane view of the HDD and electronic waste disposal apparatus of the instant invention with shielding in place;

FIG. 2 is a right side view thereof;

FIG. 3 is a cross section view taken along lines A-A of FIG. 1;

FIG. 4 is a front perspective view of the magnetic roller;

FIG. 5 is a rear perspective view of the magnetic roller;

FIG. 6 is an exploded view of the HDD and electronic waste disposal apparatus with shielding removed and the bin carriage separated;

FIG. 7A is a perspective view of a first stage knife;

FIG. 7B is a side view of the first stage knife;

FIG. 7C is an edge view of the first stage knife;

FIG. 8A is a perspective view of a first stage spacer;

FIG. 8B is a side view of the first stage spacer;

FIG. 8C is an edge view of the first stage spacer;

FIG. 9A is a perspective view of the third stage mill;

FIG. 9B is a perspective view of the third stage mill with the cover removed;

FIG. 9C is a cross sectional front view of the third stage mill;

FIG. 9D is a perspective view of the third stage mill knife blades;

FIG. 9E is an enlarged view of a knife blade from FIG. 9D;

FIG. 9F is a cross sectional side view of the third stage mill.

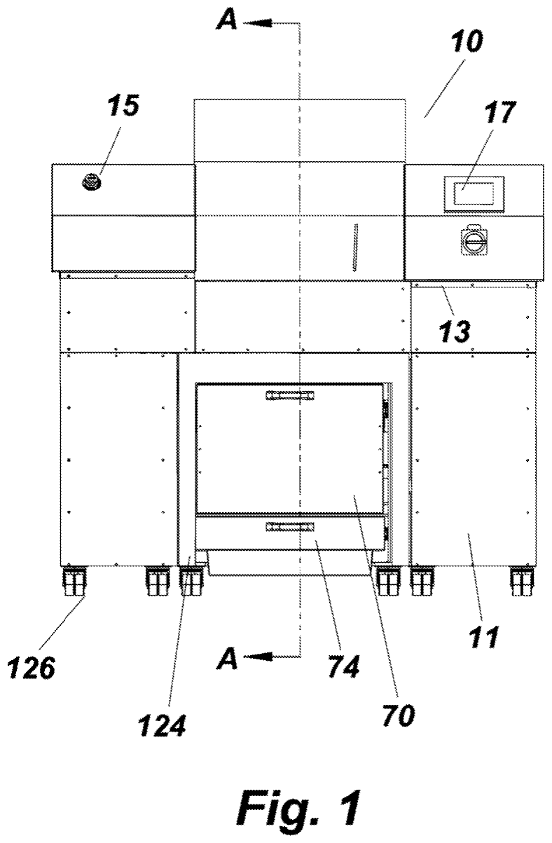

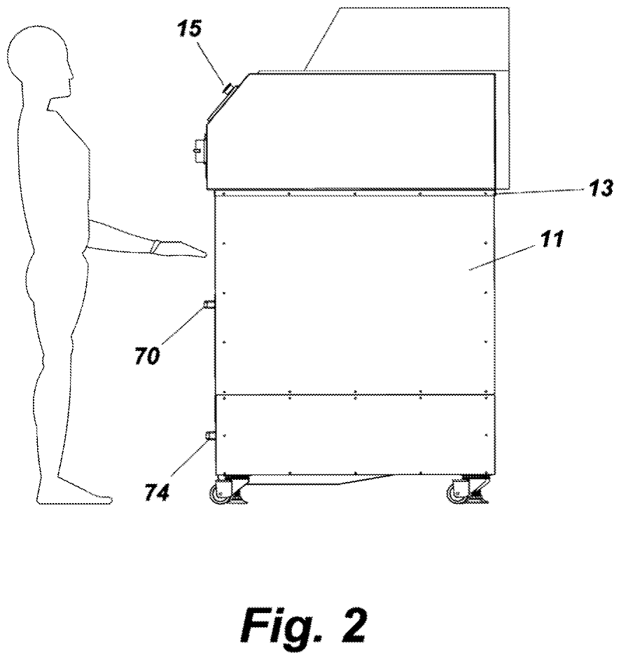

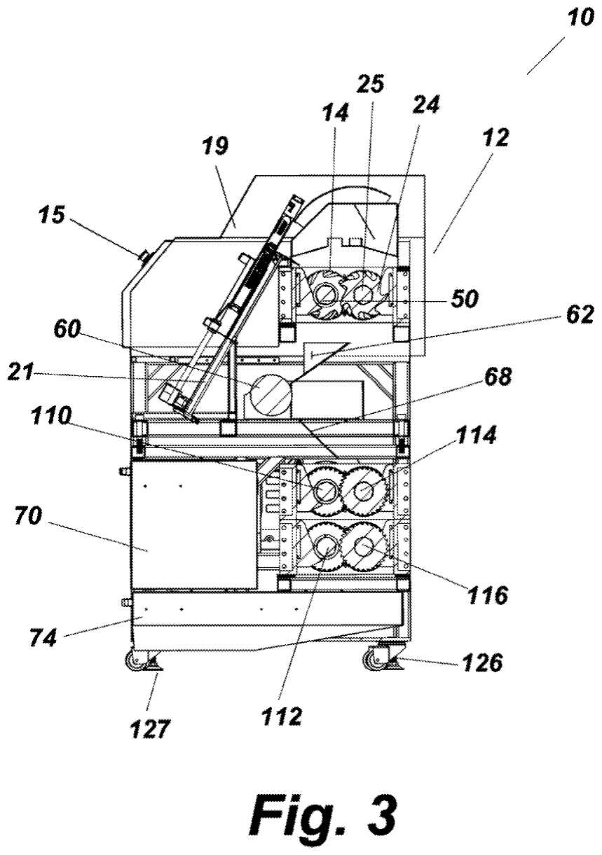

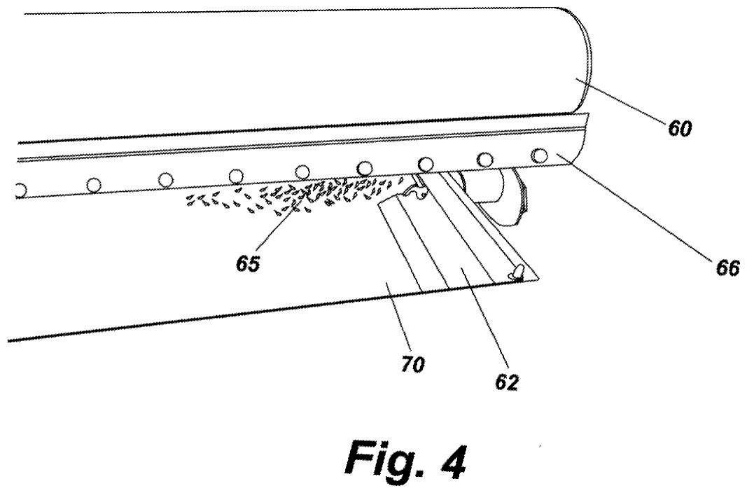

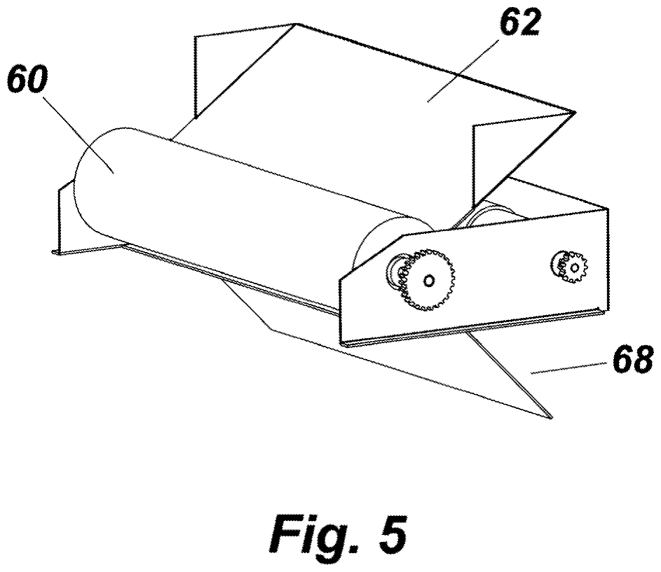

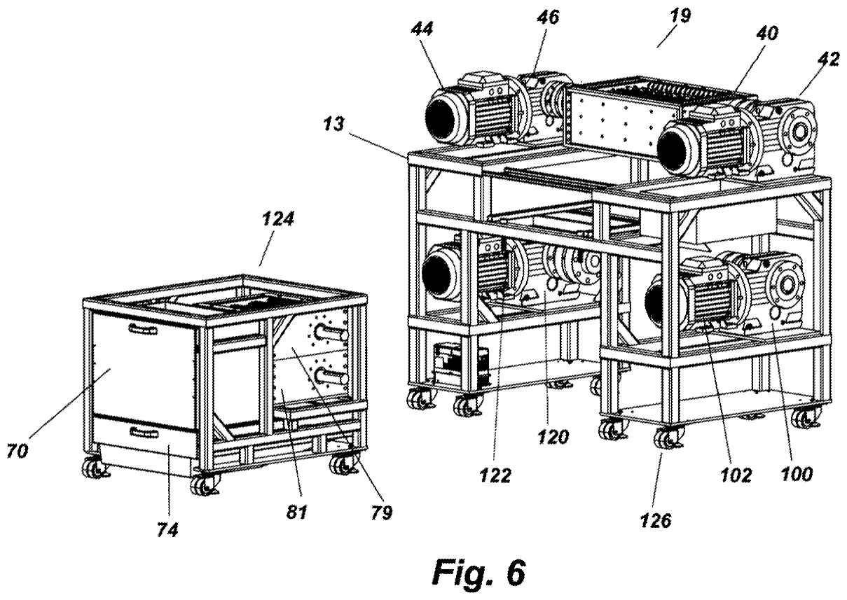

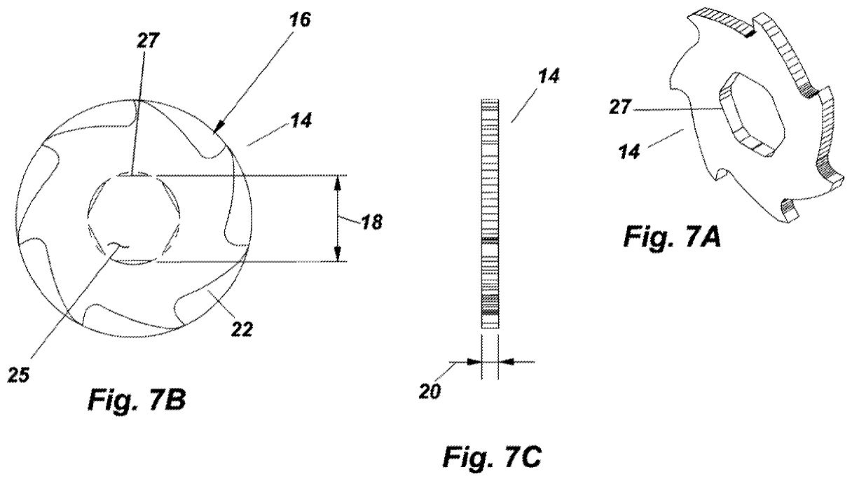

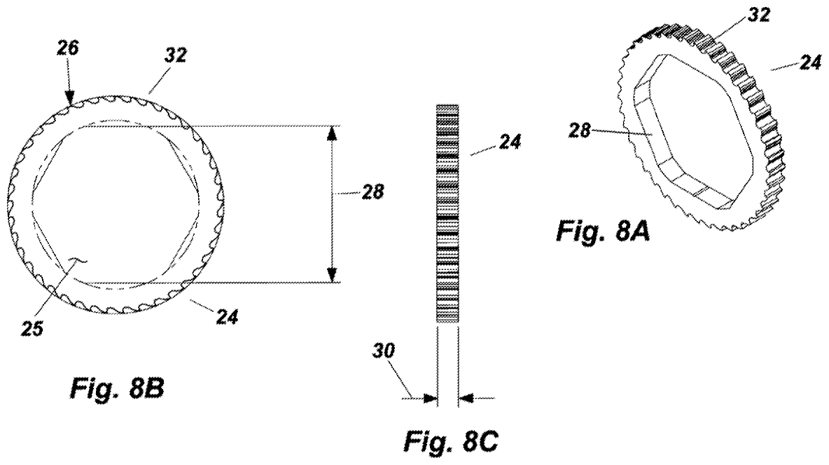

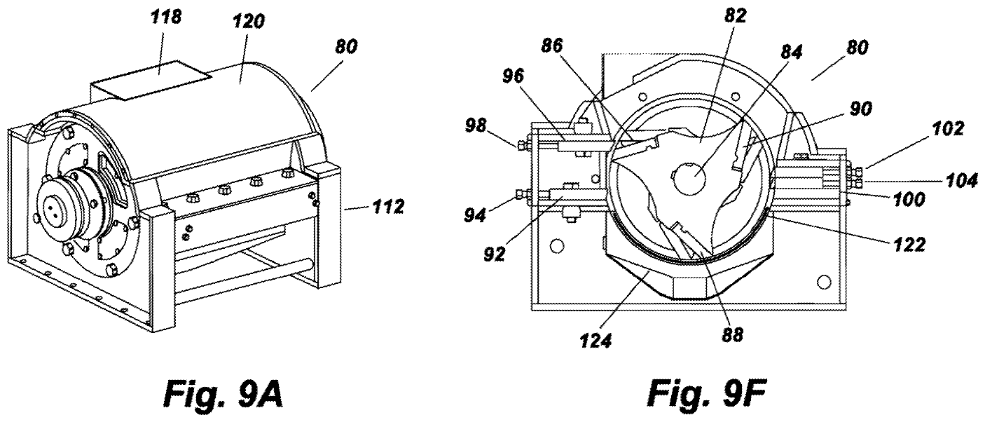

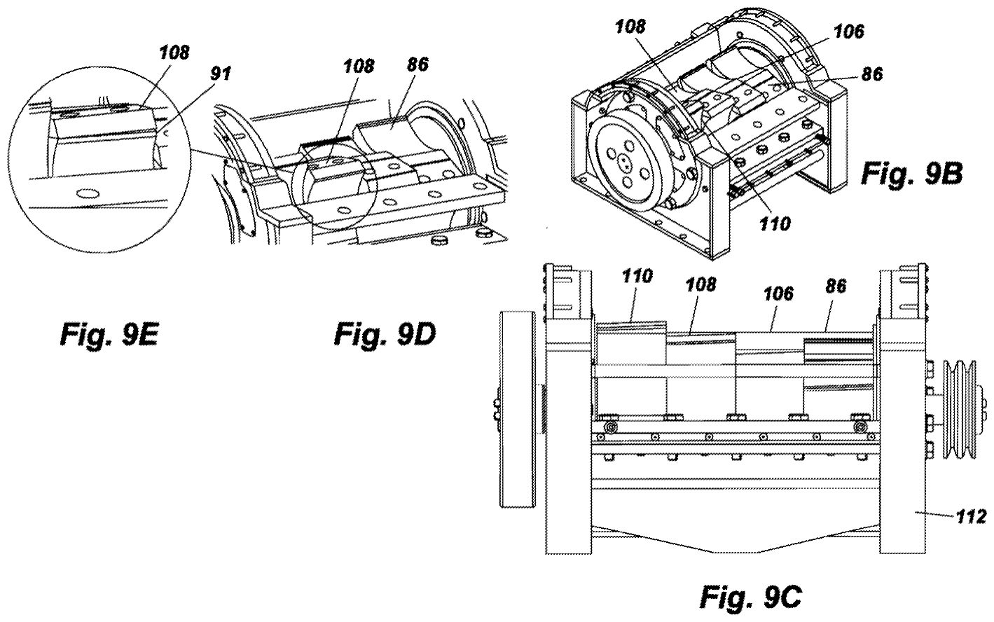

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

Referring to the Figures in general, depicted is the electronic waste disposal apparatus 10 of the instant invention employing sound and protective shields 11 attached to a main frame 13. Casters are used to stabilize the apparatus, caster wheels 126 allow movement of the apparatus as necessary. A detachable frame 124 houses a first bin 70 and a second bin 74, wherein shredded debris is separated and collected. The bins 70, 74 can be removed and emptied as needed. Further the detachable frame 124 can be pulled away from the main frame 13 for services of the bins or for access to the third stage mill having a second shredder 80 as will be further explained. The front of the apparatus 10 including an emergency shut off 15 and a control panel 17.

The first stage shredder 19 includes a shaft 25 having opposing flat surfaces 27 spaced apart 64.50 mm forming a hexagon shape. While a hexagon shape is preferred, it will be obvious to one skilled in the art that the shaft may be splined, or otherwise of a shape to assure positive transmission of torque from the shaft to the knifes 14 and spacers 24. Each knife 14 preferably having seven scallops 22. Between each knife 14 is a spacer 24 having a 90 mm outer diameter 26, a 70 mm inner diameter 28 and an 8.80 width 30 with forty one teeth 32. The inner diameter 28 constructed and arranged to receive the shaft 25. A first electric motor 50 is coupled to a gear box 42 for rotating of the shaft 25 in a clockwise direction. A second motor 44 drives a second gearbox 46 having a counter-clockwise rotation of a second shaft 50 with a plurality of reciprocal cutting knifes and blades forming a mirror image of first set of knifes and spacers forming an interlaced set of knifes and spacers. For ease of clarity a single set of knifes 14 and spacers 24 is depicted but it is understood that the clockwise rotation and counter-clockwise rotation is constructed and arranged to shred material passing between the teeth to particles no greater than 20 mm by 20 mm for the first stage.

The first stage directs shredded material to a second stage for drawing metal particles. The second stage comprises a magnetized roller 60 that receives shredded material that is funneled to the roller 60 by a ramp surface 62. A roller motor 64 rotates the roller 60 which is steel with an electro magnet causing metal particles to adhere to the roller. Metal particles 65 are removed from the roller 60 by a scraper 66, the metal particles directed to a first bin 70, non-metal particles that do not adhere to the roller are directed to a third stage by a directional chute 68. Metal particles include spindles, brackets, sleds and the like metal materials that are difficult to shred to a size less than 20 mm. Since metal particles do not store data, they do not need to be shredded further saving energy in the limited process. The scraper 66 is positioned adjacent to the roller 60 and used to scrape metal materials 65 as the roller 60 spins. The metal material removed from the roller 60 is directed to the first bin 70 and is available for recycling. The second stage allows eliminates the need to shred all materials to less than 2 mm as the second stage separates the metal from the electronic media holding element. This reduces the wear on the third stage and allows for the use of larger teeth to maintain fast component destruction. Items that benefit from treatment through the first stage in HDD, Enterprise HDD, cell/smart phones, PDA's, tablets, HDD hybrids including HAMR and MAMR, motherboards, switches, routers, PCle/NVMe, and the like electronic waste. Items that benefit from treatment through the third stage in SSC's, Enterprise SSD's circuit boards, USB/flash drives, credit cards, CD/CVS PDA's, SIM cards BLU-RAY and the like devices. Capacities allow for shredding at the rate of about 360 to 400 HDDs per hour (1 HDD every 10 seconds) based on standard form factor testing. Switches can be shredded at a rate of about 400/hr, HDD 360/hr, SSD 720/hr.

A third stage involves shredding the non-metal particles received through the chute 68 into debris measuring no greater than 2 mm by 2 mm for collection in a second collection bin 74. In this embodiment a second shredder assembly 80 uses a scissor shearing effect by placing blades at a 2 degree sloop. In particular the second shredder 80 employs a plurality of rotors 82 securable to a drive shaft 84. To lessen drawing confusion, a single rotor 82 will be enumerated but preferably four rotors are used as illustrated. In the preferred embodiment each rotor 82 has a first cutting blade 86, a second cutting blade 88, and a third cutting blade 90 attached thereto. Each cutting blade 86, 88, 90 is attached to the rotor 82 at a 2 degree slope depicted by number 91, the slope gives the advantage of generating a composition (2 directions due to the angle—tangent to the rotation and parallel to the axis of rotation) cutting force that allows the blades to shear the media particles. The shearing action increases cutting efficiency by minimizing energy loss through impact such as in the base of parallel blades. The rotational kinetic energy dissipated abruptly through impact is instead dissipated into shearing the particles with reduced rotor deceleration.

The cutting blades 86, 88, and 90 operate with the 2 degree slope in combination with a first bar blade 92 made adjustable using a threaded positioner 94. A second bar blade 96 is made adjustable using a threaded positioner 98 and parallel disposed bar blades 100 are made adjustable using threaded positioners 102, 104. Each rotor having an offset rotation allowing cutting blades 86, 106, 108, and 110 to cause the composite cutting force that allows the cutting blades to efficiently shear the media particles. Each said cutting blade is secured to a rotor by use of a threaded bolt to allow ease of service.

The second shredder includes a base 112 with a drive 114 available to driving supplement belt driven devices from a first end of the shaft 84, and a weighted coupler 116 secured to an opposite end of the shaft 84 for coupled to a drive motor. The coupler 116 is constructed and arranged to maintain a rotation speed during the shredding procedure. The base 112 includes an opening 118 for receipt of materials and a removable cover 120 for service. A screen 122 has 2 mm×2 mm opening to assure particles passing into a collection bay 124 are 2 mm×2 mm or less. An electric motor driver 93 is rotatably coupled to third gear box 95 coupled to the second shredder 80 through the weighted coupler 116.

The third stage includes a high flow regenerative mill vacuum system 130 for collection of airborne particles. The vacuum system 130 including carbon and HEPA filters to provide dust free operation.

All patents and publications mentioned in this specification are indicative of the levels of those skilled in the art to which the invention pertains. It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An apparatus for destroying electronic data and providing selective storage comprising:
a first stage for inserting data storage devices into a first shredder mounted on a support frame, said first shredder constructed and arranged to grind data storage devices into particles no greater than 20 mm by 20 mm;
a second stage for removing metal particles passed through said first shredder, said second stage comprising a magnetized roller mounted on said support frame wherein shredded particles containing metal adhere to said magnetized roller wherein a scraper directs metal particles from said magnetized roller to a first collection bin;
a third stage for shearing non-metal particles comprising a second shredder having a support base with a plurality of adjustable bar plates, said support base including a plurality of rotors having cutting blades removably coupled thereto, said cutting blades and said adjustable bar blades constructed and arranged to shear non-metal particles to a size of less than 2 mm by 2 mm; and
a screen allowing passage of shredded non-metal particles into a second collection bin;
wherein said first collection bin holds metal particles no greater than 20 mm by 20 mm and said second collection bin holds non-metal particles no greater than 2 mm by 2 mm.

2. The apparatus for destroying electronic data and providing selective storage according to claim 1 wherein said first and second bin are mounted to a detachable frame.

3. The apparatus for destroying electronic data and providing selective storage according to claim 2 wherein said second shredder is mounted to said detachable frame.

4. The apparatus for destroying electronic data and providing selective storage according to claim 1 wherein said second stage includes four rotors, each rotor having three equally spaced cutting blades.

5. The apparatus for destroying electronic data and providing selective storage according to claim 4 wherein each said rotor is offset to an adjacent rotor.

6. The apparatus for destroying electronic data and providing selective storage according to claim 4 wherein each said cutting blade is releasably attached to a rotor by a fastener. cm 7. The apparatus for destroying electronic data and providing selective storage according to claim 6 wherein each said cutting blade is releasably attached to a rotor with a 2 degree slope.

8. The apparatus for destroying electronic data and providing selective storage according to claim 1 wherein said first shredder includes a plurality of clockwise rotating cut knives and a plurality of spacers each having teeth coupled to a shaft that is rotatable in a clockwise direction from a first gearbox coupled to a first motor, a plurality of reciprocal cutting knives and blades forming a mirror image of said clockwise rotating knives and spacers are coupled to a counter-rotating shaft coupled to a second gear box driven by a second motor, said first shredder constructed and arranged to grind material passing between said shafts to particles no greater than 20 mm by 20 mm.

9. The apparatus for destroying electronic data and providing selective storage according to claim 1 including a vacuum system for collection of airborne particles fluidly coupled to said second shredder.

10. An apparatus for destroying electronic data and providing selective storage comprising:
a first stage for inserting data storage devices into a first shredder mounted on a support frame, said first shredder constructed and arranged to grind data storage devices into particles no greater than 20 mm by 20 mm;
a second stage for removing metal particles passed through said first shredder, said second stage comprising a magnetized roller mounted on said support frame wherein shredded particles containing metal adhere to said magnetized roller wherein a scraper directs metal particles from said magnetized roller to a first collection bin;
a third stage for grinding non-metal particles comprising a second shredder having a support base with a plurality of adjustable bar plates, said support base including four rotors, each said rotor offset to an adjacent rotor with three equally spaced cutting blades position at a 2 degree slope, said cutting blades and said adjustable bar blades constructed and arranged to shear non metal particles;
a screen allowing passage of particles measuring no greater than 2 mm by 2 mm for collection in a second collection bin; and
a vacuum system for collection of airborne particles fluidly coupled to said collection bin;
wherein said first collection bin holds metal particles no greater than 20 mm by 20 mm and said second collection bin holds non-metal particles no greater than 2 mm by 2 mm.

11. The apparatus for destroying electronic data and providing selective storage according to claim 10 wherein said first and second bin are mounted to a detachable frame.

12. The apparatus for destroying electronic data and

11. g selective storage according to claim 11 wherein said second shredder is mounted to said detachable frame.

13. The apparatus for destroying electronic data and providing selective storage according to claim 10 wherein each said cutting blade is releasably attached to a rotor by a fastener.

14. The apparatus for destroying electronic data and providing selective storage according to claim 10 including a HEPA filter operatively associated with said vacuum system for collection of airborne particles.
